(19) United States
(12) Patent Application Publication
(10) Pub. No.: US 2019/0138603 A1
(43) Pub. Date: May 9, 2019

(54) Coordinating Translation Request Metadata between Devices

(71) Applicant: Bose Corporation, Framingham, MA (US)

(72) Inventors: Michael J. Daley, Shrewsbury, MA (US); Naganagouda B. Patil, Ashland, MA (US)

(73) Assignee: Bose Corporation, Framingham, MA (US)

(21) Appl. No.: 16/180,583

(22) Filed: Nov. 5, 2018

Related U.S. Application Data
(60) Provisional application No. 62/582,118, filed on Nov. 6, 2017.

(51) Int. Cl. G06F 17/28; G06F 3/16; H04R 1/40

(52) U.S. Cl. CPC G06F 17/289; H04R 1/406; G06F 3/167

(57) ABSTRACT

A wearable apparatus has a loudspeaker configured to play sound into free space, an array of microphones, and a first communication interface. An interface to a translation service is in communication with the first communication interface via a second communication interface. The wearable apparatus and interface to the translation service cooperatively obtain an input audio signal containing an utterance from the microphones, determine whether the utterance originated from the wearer or from someone else, and obtain a translation of the utterance from the translation service. The translation response includes an output audio signal including a translated version of the utterance. The wearable apparatus outputs the translation via the loudspeaker. At least one communication between two of the wearable device, the interface to the translation service, and the translation service includes metadata indicating which of the wearer or the other person was the source of the utterance.

### CLAIM TO PRIORITY

This application claims priority to U.S. Provisional Application 62/582,118, filed Nov. 6, 2017.

### BACKGROUND

This disclosure relates to coordinating translation request metadata between devices, and in particular, communicating, between devices, associations between speakers in a conversation and particular translation requests and responses.

U.S. Pat. No. 9,571,917, incorporated here by reference, describes a device to be worn around a user's neck, which output sounds in such a way that it is more audible or intelligible to the wearer than to others in the vicinity. U.S. patent application Ser. No. 15/220,535 filed Jul. 27, 2016, and incorporated here by reference, describes using that device for translation purposes. U.S. patent application Ser. No. 15/220,479, filed Jul. 27, 2016, and incorporated here by reference, describes a variant of that device which includes a configuration and mode in which sound is alternatively directed away from the user, so that it is audible to and intelligible by a person facing the wearer. This facilitates use as a two-way translation device, with the translation of both the user's and another person's utterances being output in the mode more audible and intelligible by the other person.

### SUMMARY

In general, in one aspect, a system for translating speech includes a wearable apparatus with a loudspeaker configured to play sound into free space, an array of microphones, and a first communication interface. An interface to a translation service is in communication with the first communication interface via a second communication interface. Processors in the wearable apparatus and interface to the translation service cooperatively obtain an input audio signal from the array of microphones, the audio signal containing an utterance, determine whether the utterance originated from a wearer of the apparatus or from a person other than the wearer, and obtain a translation of the utterance by sending a translation request to the translation service and receiving a translation response from the translation service. The translation response includes an output audio signal including a translated version of the utterance. The wearable apparatus outputs the translation via the loudspeaker. At least one communication between two of the wearable device, the interface to the translation service, and the translation service includes metadata indicating which of the wearer or the other person was the source of the utterance.

Implementations may include one or more of the following, in any combination. The interface to the translation service may include a mobile computing device including a third communication interface for communicating over a network. The interface to the translation service may include the translation service itself, the first and second communication interfaces both including interfaces for communicating over a network. At least one communication between two of the wearable device, the interface to the translation service, and the translation service may include metadata indicating which of the wearer or the other person may be the audience for the translation. The communication including the metadata indicating the source of the utterance and the communication including the metadata indicating the audience for the translation may be the same communication. The communication including the metadata indicating the source of the utterance and the communication including the metadata indicating the audience for the translation may be separate communications. The translation response may include the metadata indicating the audience for the translation.

Obtaining the translation may also include transmitting the input audio signal to the mobile computing device, instructing the mobile computing device to perform the steps of sending the translation request to the translation service and receiving the translation request form the translation service, and receiving the output audio signal from the mobile computing device. The metadata indicating the source of the utterance may be attached to the request by the wearable apparatus. The metadata indicating the source of the utterance may be attached to the request by the mobile computing device.

The mobile computing may determine whether the utterance originated from the wearer or from the other person by applying two different sets of filters to the first audio signal to produce two filtered audio signals, and comparing a speech-to-noise ratio in each of the two filtered audio signals. At least one communication between two of the wearable device, the interface to the translation service, and the translation service may include metadata indicating which of the wearer or the other person is the audience for the translation, and the metadata indicating the audience for the translation may be attached to the request by the wearable apparatus. The metadata indicating the audience for the translation may be attached to the request by the mobile computing device. The metadata indicating the audience for the translation may be attached to the request by the translation service. The wearable apparatus may determine whether the utterance originated from the wearer or from the other person before sending the translation request, by applying two different sets of filters to the first audio signal to produce two filtered audio signals, and comparing a speech-to-noise ratio in each of the two filtered audio signals.

In general, in one aspect, a wearable apparatus includes a loudspeaker configured to play sound into free space, an array of microphones, and a processor configured to receive inputs from each microphone of the array of microphones. In a first mode, the processor filters and combines the microphone inputs to operate the microphones as a beam-forming array most sensitive to sound from the expected location of the wearer of the device's own mouth. In a second mode, the processor filters and combines the microphone inputs to operate the microphones as a beam-forming array most sensitive to sound from a point where a person speaking to the wearer is likely to be located.

Implementations may include one or more of the following, in any combination. The processor may, in a third mode, filter output audio signals so that when output by the loudspeaker, they are more audible at the ears of the wearer of the apparatus than at a point distant from the apparatus, and in a fourth mode, filter output audio signals so that when output by the loudspeaker, they are more audible at a point distant from the wearer of the apparatus than at the wearer's ears. The processor may be in communication with a speech translation service, and may, in both the first mode and the second mode, obtain translations of speech detected by the microphone array, and use the loudspeaker to play back the translation. The microphones may be located in acoustic nulls of a rotation pattern of the loudspeaker. The processor may operate in both the first mode and the second mode in parallel, producing two input audio streams representing the outputs of both beam forming arrays. The processor may operate in both the third mode and the fourth mode in parallel, producing two output audio streams that will be superimposed when output by the loudspeaker. The processor may provide the same audio signals to both the third mode filtering and the fourth mode filtering. The processor may operate in all four of the first, second, third, and fourth modes in parallel, producing two input audio streams representing the outputs of both beam forming arrays and producing two output audio streams that will be superimposed when output by the loudspeaker. The processor may be in communication with a speech translation service, and may obtain translations of speech in both the first and section input audio streams, output the translation of the first audio stream using the fourth mode filtering, and output the translation of the second audio stream using the third mode filtering.

Advantages include allowing the user to engage in a two-way translated conversation, without having to indicate to the hardware who is speaking and who needs to hear the translation of each utterance.

All examples and features mentioned above can be combined in any technically possible way. Other features and advantages will be apparent from the description and the claims.

### BRIEF DESCRIPTION OF THE DRAWINGS

FIG. 1 shows a wearable speaker device on a person.

FIG. 2 shows a headphone device.

FIG. 3 shows a wearable speaker device in communication with a translation service through a network interface device and a network.

FIGS. 4A-4D and 5 show data flow between devices.

### DESCRIPTION

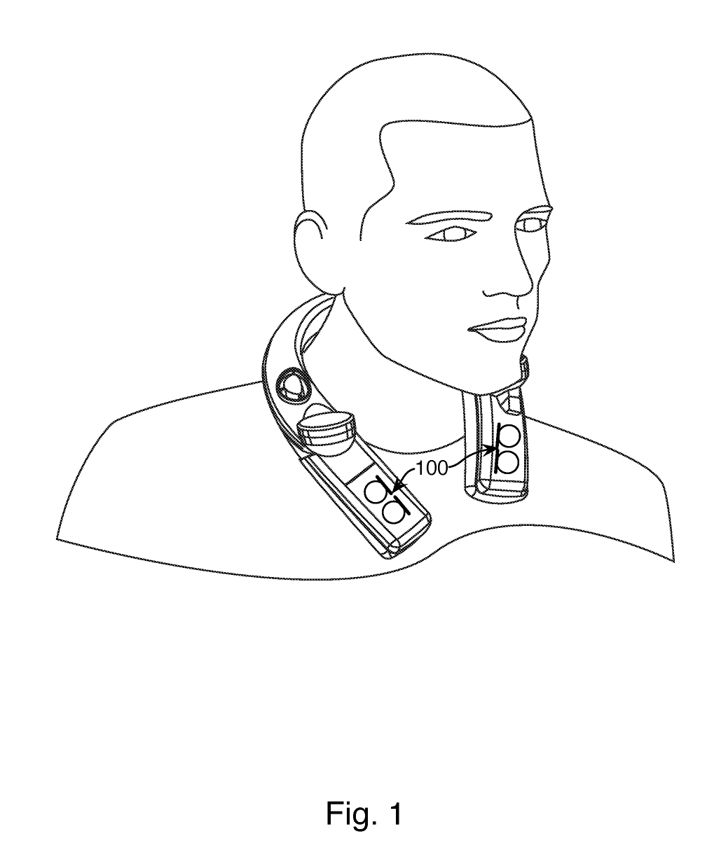

To further improve the utility of the device described in the '917 patent, an array 100 of microphones is included, as shown in FIG. 1. The same or similar array may be included in the modified version of the device. In either embodiment, beam-forming filters are applied to the signals output by the microphones to control the sensitivity patterns of the microphone array 100. In a first mode, the beam-forming filters cause the array to be more sensitive to signals coming from the expected location of the mouth of the person wearing the device, who we call the “user.” In a second mode, the beam-forming filters cause the array to be more sensitive to signals coming from the expected location (not shown) of the mouth of a person facing the person wearing the device, i.e., at about the same height, centered, and one to two meters away. We call this person the “partner.” It happens that the original version of the device, described in the '917 patent, has similar audibility to a conversation partner as it has to the wearer—that is, the ability of the device to confine its audible output to the user is most effective for distances greater than where someone having a face-to-face conversation with the user would be located.

Thus, at least three modes of operation are provided: the user may be speaking (and the microphone array detecting his speech), the partner may be speaking (and the microphone array detecting her speech), the speaker may be outputting a translation of the user's speech so that the partner can hear it, or the speaker may be outputting a translation of the partner's speech so that the user can hear it (the latter two modes may not be different, depending on the acoustics of the device). In another embodiment, discussed later, the speaker may be outputting a translation of the user's own speech back to the user. If each party is wearing a translation device, each device can translate the other person's speech for its own user, without any electronic communication between the devices. If electronic communication is available, the system described below may be even more useful, by sharing state information between the two devices, to coordinate who is talking and who is listening.

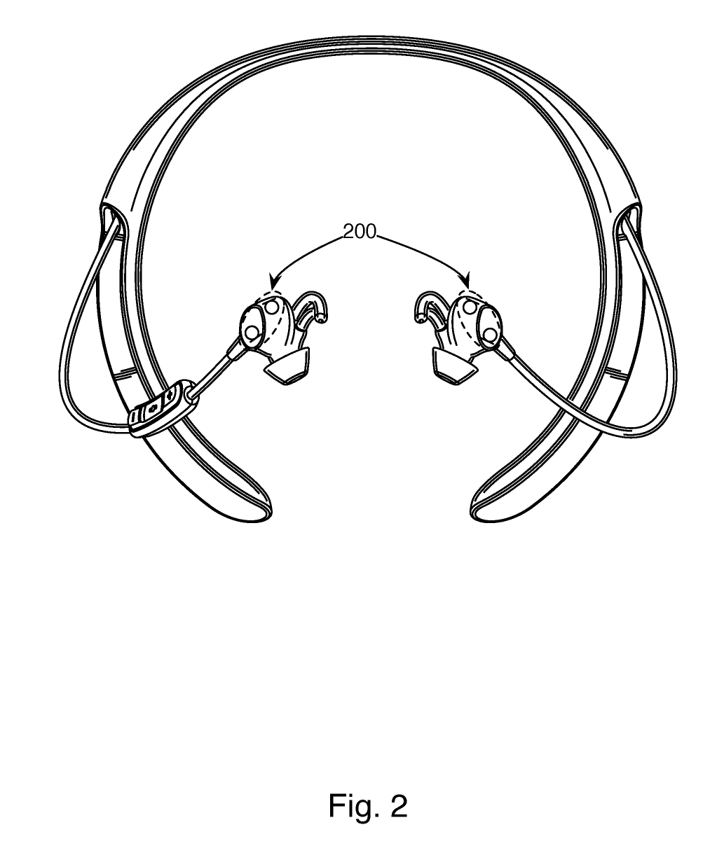

The same modes of operation may also be relevant in a more conventional headphone device, such as that shown in FIG. 2. In particular, a device such as the headphones described in U.S. patent application Ser. No. 15/347,419, the entire contents of which are incorporated here by reference, includes a microphone array 200 that can be alternatively used both to detect a conversation partner's speech, and to detect the speech of its own user. Such a device may reply translated speech to its own user, though it lacks an out-loud playback capability for playing a translation of its own user to a partner. Again, if both users are using such a device (or one is using the device described above and another is using headphones), the system described below is useful even without electronic communication, but even more powerful with it.

Two or more of the various modes may be active simultaneously. For example, the speaker may be outputting translated speech to the partner while the user is still speaking, or vice-versa. In this situation, standard echo cancellation can be used to remove the output audio from the audio detected by the microphones. This may be improved by locating the microphones in acoustic nulls of the radiation pattern of the speaker. In another example the user and the partner may both be speaking at the same time—the beamforming algorithms for the two input modes may be executed in parallel, producing two audio signals, one primarily containing the user's speech, and the other primarily containing the partner's speech. In another example, if there is sufficient separation between the radiation patterns in the two output modes, two translations may be output simultaneously, one to the user and one to the partner, by superimposing two output audio streams, one processed for the user-focused radiation pattern and the other processed for the partner-focused radiation pattern. If enough separation exists, it may be possible for all four modes to be active at once—both user and partner speaking, and both hearing a translation of what the other is saying, all at the same time.

### Metadata

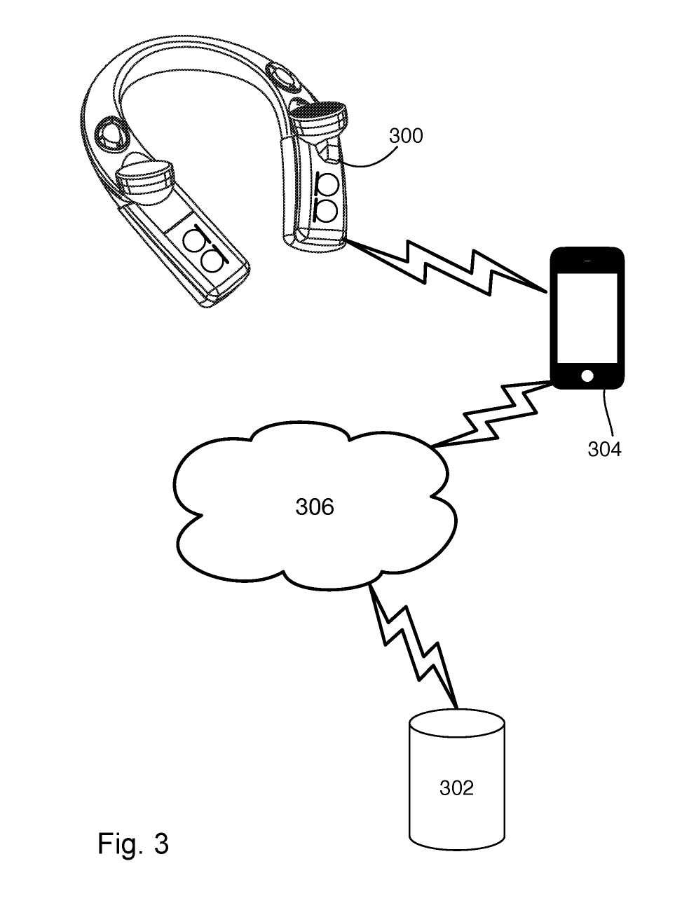

Multiple devices and services are involved in implementing the translation device contemplated, as shown in FIG. 3. First, there is the speaker device 300 discussed above, incorporating microphones and speakers for detecting utterances and outputting translations of them. This device may alternatively be provided by a headset, or by separate speakers and microphones. Some or all of the discussed systems may be relevant to any acoustic embodiment. Second, a translation service 302, shown as a cloud-based service, receives electronic representations of the utterances detected by the microphones, and responds with a translation for output. Third, a network interface, shown as a smart phone 304, relays the data between the speaker device 300 and the translation service 302, through a network 306. In various implementations, some or all of these devices may be more distributed or more integrated than is shown. For example, the speaker device may contain an integrated network interface used to access the translation service without an intervening smart phone. The smart phone may implement the translation service internally, without needing network resources. With sufficient computing power, the speaker device may carry out the translation itself and not need any of the other devices or services. The particular topology may determine which of the data structures discussed below are needed. For purposes of this disclosure, it is assumed that all three of the speaker device, the network interface, and the translation service, are discrete from each other, and that each contains a processor capable of manipulating or transferring audio signals and related metadata, and a wireless interface for connecting to the other devices.

In order to keep track of which mode to use at any given time, and in particular, which output mode to use for a given response from the translation service, a set of flags are defined and are communicated between the devices as metadata accompanying the audio data. For example, four flags may indicate whether (1) the user is speaking, (2) the partner is speaking, (3) the output is for the user, and (4) the output is for the partner. Any suitable data structure for communicating such information may be used, such as a simple four-bit word with each bit mapped to one flag, or a more complex data structure with multiple-bit values representing each flag. The flags are associated with the data representing audio signals being passed between devices so that each device is aware of the context of a given audio signal. In various examples, the flags may be embedded in the audio signal, in metadata accompanying the audio signal, or sent separately via the same communication channel or a different one. In some cases, a given device doesn't actually care about the context, that is, how it handles a signal does not depend on the context, but it will still pass on the flags so that the other devices can be aware of the context.

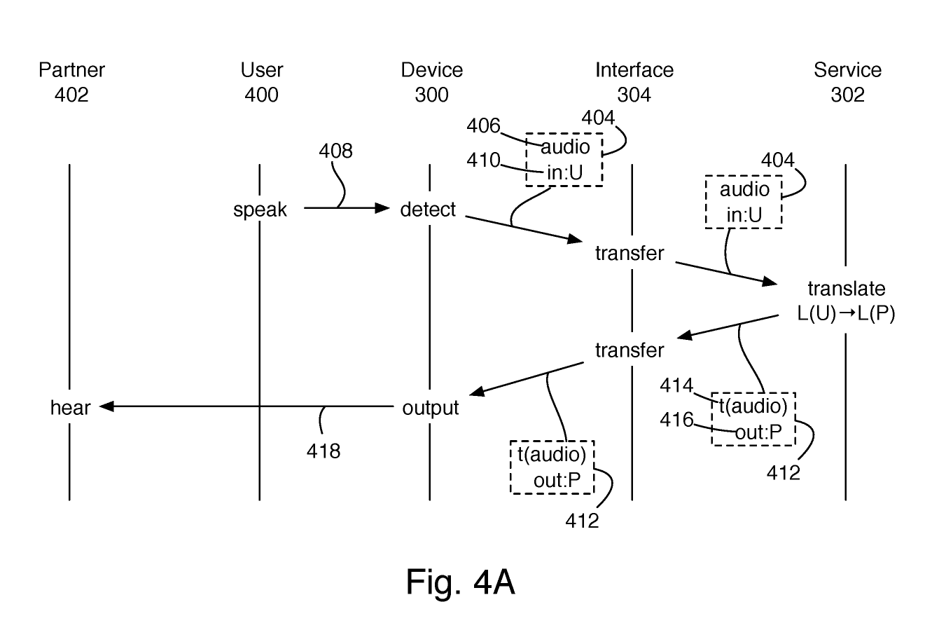

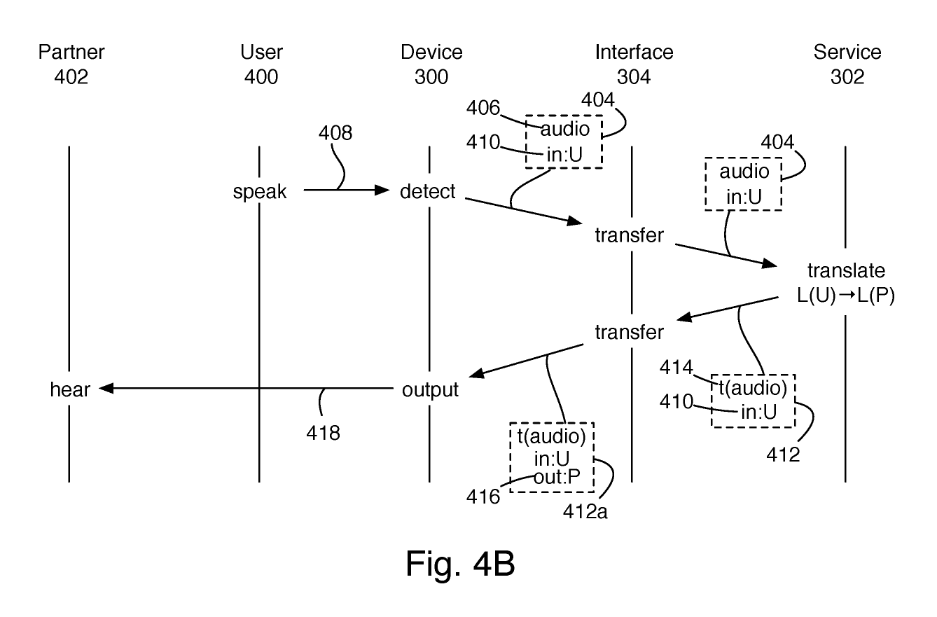

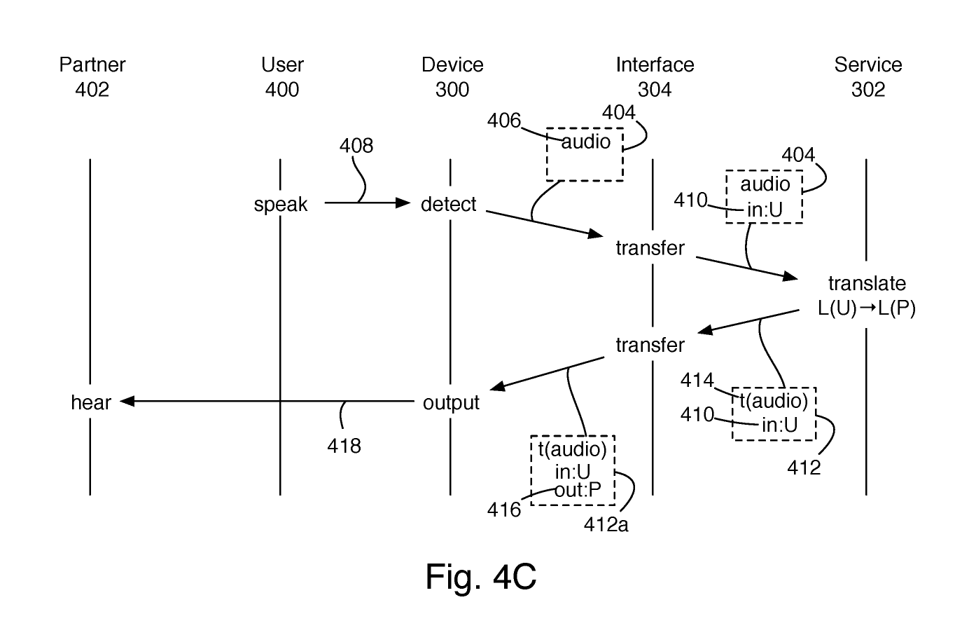

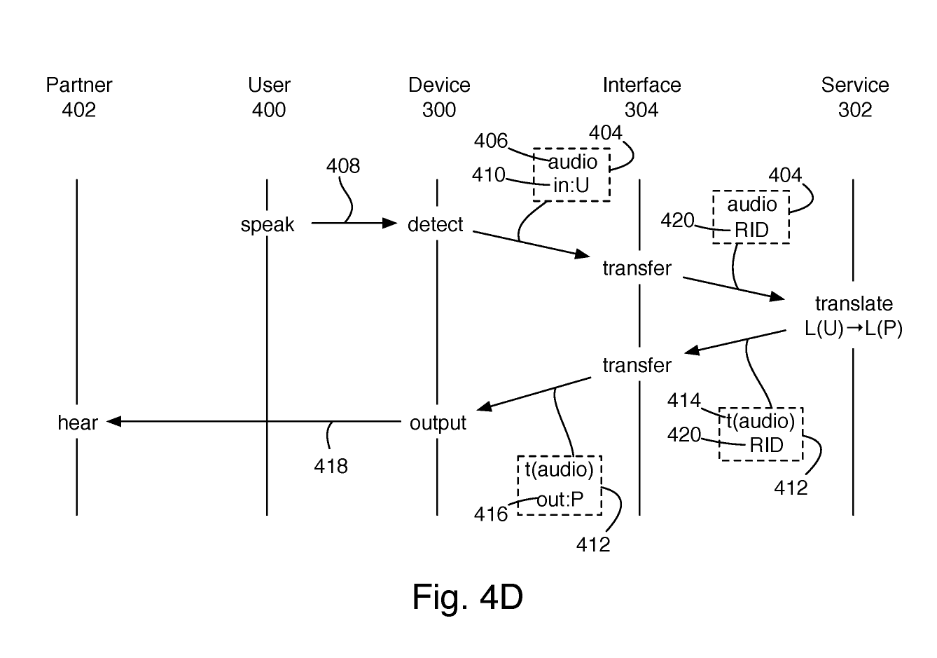

Various communication flows are shown in FIGS. 4A-4D. In each, the potential participants are arranged along the top—the user 400, conversation partner 402, user's device 300, network interface 304, and the translation service 302. Actions of each are shown along the lines descending from them, with the vertical position reflecting rough order as the data flows through the system. In one example, shown in FIG. 4A, an outbound request 404 from the speaker device 300 consists of an audio signal 406 representing speech 408 of the user 400 (i.e., the output of the beam-forming filter that is more sensitive to the user's speech; in other examples, identification of the speaker could be inferred from the language spoken), and a flag 410 identifying it as such. This request 404 is passed through the network interface 304 to the translation service 302. The translation service receives the audio signal 406, translates it, and generates a responsive translation for output. A response 412 including the translated audio signal 414 and a new flag 416 identifying it as output for the partner 402 is sent back to the speaker device 300 through the network interface 304. The user's device 300 renders the audio signal 414 as output audio 418 audible by the partner 402.

In one alternative, not shown, the original flag 410, indicating that the user is speaking, is maintained and attached to the response 412 instead of the flag 416. It is up to the speaker device 300 to decide who to output the response to, based on who was speaking, i.e., the flag 410, and what mode the device is in, such as conversation or education modes.

In another example, shown in FIG. 4B, the network interface 304 is more involved in the interaction, inserting the output flag 416 itself before forwarding the modified response 412a (which includes the original speaker flag 410) from the translation service to the speaker device. In another example, the audio signal 406 in the original communication 404 from the speaker device includes raw microphone audio signals and the flag 410 identifying who is speaking. The network interface applies the beam-forming filters itself, based on the flag, and replaces the raw audio with the filter output when forwarding the request 404 to the translation service. Similarly, the network interface may filter the audio signal it receives in response, based on who the output will be for, before sending it to the speaker device. In this example, the output flag 416 may not be needed, as the network interface has already filtered the audio signal for output, but it may still be preferable to include it, as the speaker may provide additional processing or other user interface actions, such as a visible indicator, based on the output flag.

In another variation of this example, shown in FIG. 4C, the input flag 410 is not set by the speaker. The network interface applies both sets of beam-forming filters to the raw audio signals 406, and compares the amount of speech content in the two outputs to determine who is speaking and to set the flag 410. In some examples, as shown in FIG. 4D, the translation service is not itself aware of the flags, but they are effectively maintained through communication with the service by virtue of individual request identifiers used to associate a response with a request. That is, the network interface attaches a unique request ID 420 when sending an audio signal to the translation service (or such an ID is provided by the service when receiving the request), and that request ID is attached to the response from the translation service. The network interface matches the request ID to the original flag, or to the appropriate output flag. It will be appreciated that any combination of which device is doing which processing can be implemented, and some of the flags may be omitted based on such combinations. In general, however, it is expected that the more contextual information that is included with each request and response, the better.

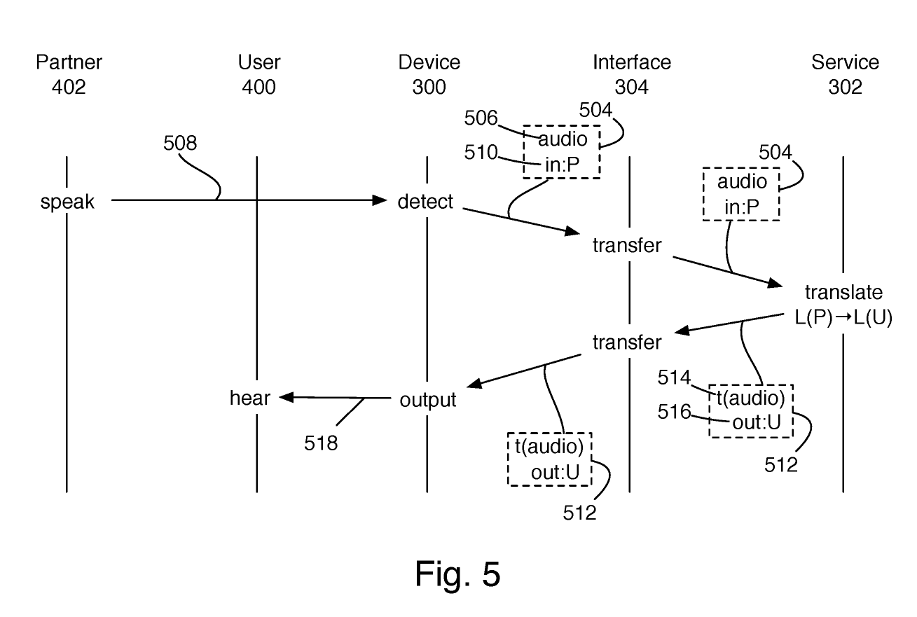

FIG. 5 shows the similar topology when the conversation partner is the one speaking. Only the example of FIG. 4A is reflected in FIG. 5—similar modifications for the variations discussed above would also be applicable. The utterance 508 by the conversation partner 402 is encoded as signal 506 in request 504 along with flag 510 identifying the partner as the speaker. The response 512 from translation service 302 includes translated audio 514 and flag 516 identifying it as being intended for the user. This is converted to output audio 518 provided to the user 400.

In some examples, the flags are useful for more than simply indicating which input our output beamforming filter to use. It is implicit in the use of a translation service that more than one language is involved. In the simple situation, the user speaks a first language, and the partner speaks a second. The user's speech is translated into the partner's language, and vice-versa. In more complicated examples, one or both of the user and the partner may want to listen to a different language than they are themselves speaking. For example, it may be that the translation service translates Portuguese into English well, but translates English into Spanish with better accuracy than it does into Portuguese. A native Portuguese speaker who understands Spanish may choose to listen to a Spanish translation of their partner's spoken English, while still speaking their native Portuguese. In some situations, the translation service itself is able to identify the language in a translation request, and it needs to be told only which language the output is desired in. In other examples, both the input and the output language need to be identified. This identification can be done based on the flags, at whichever link in the chain knows the input and output languages of the user and the partner.

In one example, the speaker device knows both (or all four) language settings, and communicates that along with the input and output flags. In other examples, the network interface knows the language settings, and adds that information when relaying the requests to the translation service. In yet another example, the translation service knows the preferences of the user and partner (perhaps because account IDs or demographic information was transferred at the start of the conversation, or with each request). Note that the language preferences for the partner may not be based on an individual, but based on the geographic location where the device is being used, or on a setting provided by the user based on who he expects to interact with. In another example, only the user's language is known up-front, and the partner language is set based on the first statement provided by the partner in the conversation. Conversely, the speaker device could be located at an established location, such as a tourist attraction, and it is the user's language that is determined dynamically, while the partner's language is known.

In the modes where the network interface or the translation service is the one deciding which languages to use, the flags are at least in part the basis of that decision-making. That is, when the flag from the speaker device identifies a request as coming from the user, the network interface or the translation service know that the request is in the input language of the user, and should be translated into the output language of the partner. At some point, the audio signals are likely to be converted to text, the text is what is translated, and that text is converted back to the audio signals. This conversion may be done at any point in the system, and the speech-to-text and text-to-speech do not need to be done at the same point in the system. It is also possible that the translation is done directly in audio—either by a human translator employed by the translation service, or by advanced artificial intelligence. The mechanics of the translation are not within the scope of the present application.

### Further Details of Each of the Modes

Various modes of operating the device described above are possible, and may impact the details of the metadata exchanged. In one example, both the user and the partner are speaking simultaneously, and both sets of beamforming filters are used in parallel. If this is done in the device, it will output two audio streams, and flag them accordingly, as, e.g., “user with partner in background” and “partner with user in background.” Identifying not only who is speaking, but who is in the background, and in particular, that the two audio streams are complementary (i.e., the background noise in each contains the primary signal in the other) can help the translation system (or a speech-to-text front-end) better extract the signal of interest (the user or partner's voice) from the signals than the beamforming alone accomplishes. Alternatively, the speaker device may output all four (or more) microphone signals to the network interface, so that the network interface or the translation service can apply beamforming or any other analysis to pick out both participant's speech. In this case the data from the speaker system may only be flagged as raw, and the device doing the analysis attaches the tags about signal content.

In another example, the user of the speaker device wants to hear the translation of his own voice, rather than outputting it to a partner. The user may be using the device as a learning aid, asking how to say something in a foreign language, or wanting to hear his own attempts to speak a foreign language translated back into his own as feedback on his learning. In another use case, the user may want to hear the translation himself, and then say it himself to the conversation partner, rather than letting the conversation partner hear the translation provided by the translation service. There could be any number of social or practical reasons for this. The same flags may be used to provide context to the audio signals, but how the audio is handled based on the tags may vary from the two-way conversation mode discussed above.

In the pre-translating mode, the translation of the user's own speech is provided to the user, so the “user speaking” flag, attached to the translation response (or replaced by a “translation of user's speech” flag) tells the speaker system to output the response to the user, opposite of the previous mode. There may be a further flag needed, to identify “user speaking output language,” so that a translation is not provided when the user is speaking the partner's language. This could be automatically added by identifying the language the user is speaker for each utterance, or matching the sound of the user's speech to the translation response he was just given—if the user is repeating the last output, it doesn't need to be translated again. It is possible that the speaker device doesn't bother to output the user's speech in the partner's language, if it can perform this analysis itself; alternatively, it simply attaches the “user speaking” tag to the output, and the other devices amend that to “user speaking partner's language.” The other direction, translating the partner's speech to the user's language and outputting it to the user, remains as described above.

In the user-only language learning mode, the flags may not be needed, as all inputs are assumed to come from the user, and all outputs are provided to the user. The flags may still be useful, however, to provide the user with more capabilities, such as interacting with a teacher or language coach. This may be the same as the pre-translating mode, or other changes may also be made.

Embodiments of the systems and methods described above comprise computer components and computer-implemented steps that will be apparent to those skilled in the art. For example, it should be understood by one of skill in the art that the computer-implemented steps may be stored as computer-executable instructions on a computer-readable medium such as, for example, hard disks, optical disks, solid-state disks, flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

A number of implementations have been described. Nevertheless, it will be understood that additional modifications may be made without departing from the scope of the inventive concepts described herein, and, accordingly, other embodiments are within the scope of the following claims.

What is claimed is:

1. A system for translating speech, comprising:
a wearable apparatus comprising:
a loudspeaker configured to play sound into free space,
an array of microphones, and
a first communication interface; and
an interface to a translation service, the interface to the translation service in communication with the first communication interface via a second communication interface;
wherein processors in the wearable apparatus and interface to the translation service are configured to, cooperatively:
obtain an input audio signal from the array of microphones, the audio signal containing an utterance;
determine whether the utterance originated from a wearer of the apparatus or from a person other than the wearer;
obtain a translation of the utterance by
sending a translation request to the translation service, and
receiving a translation response from the translation service, the translation response including an output audio signal comprising a translated version of the utterance; and
output the translation via the loudspeaker; and
wherein at least one communication between two of (i) the wearable device, (ii) the interface to the translation service, and (iii) the translation service includes metadata indicating which of the wearer or the other person was the source of the utterance.

2. The system of claim 1, wherein the interface to the translation service comprises a mobile computing device including a third communication interface for communicating over a network.

3. The system of claim 1, wherein the interface to the translation service comprises the translation service itself, the first and second communication interfaces both comprising interfaces for communicating over a network.

4. The system of claim 1, wherein at least one communication between two of (i) the wearable device, (ii) the interface to the translation service, and (iii) the translation service includes metadata indicating which of the wearer or the other person is the audience for the translation.

5. The system of claim 4, wherein the communication including the metadata indicating the source of the utterance and the communication including the metadata indicating the audience for the translation are the same communication.

6. The system of claim 4, wherein the communication including the metadata indicating the source of the utterance and the communication including the metadata indicating the audience for the translation are separate communications.

7. The system of claim 6, wherein the translation response includes the metadata indicating the audience for the translation.

8. The system of claim 1, wherein obtaining the translation further comprises:
transmitting the input audio signal to the mobile computing device,
instructing the mobile computing device to perform the steps of sending the translation request to the translation service and receiving the translation request form the translation service, and
receiving the output audio signal from the mobile computing device.

9. The system apparatus of claim 8, wherein the metadata indicating the source of the utterance is attached to the request by the wearable apparatus.

10. The system of claim 8, wherein the metadata indicating the source of the utterance is attached to the request by the mobile computing device.

11. The system of claim 10, wherein the mobile computing determines whether the utterance originated from the wearer or from the other person by applying two different sets of filters to the first audio signal to produce two filtered audio signals, and comparing a speech-to-noise ratio in each of the two filtered audio signals.

12. The system of claim 8, wherein
at least one communication between two of (i) the wearable device, (ii) the interface to the translation service, and (iii) the translation service includes metadata indicating which of the wearer or the other person is the audience for the translation, and
the metadata indicating the audience for the translation is attached to the request by the wearable apparatus.

13. The system of claim 8, wherein
at least one communication between two of (i) the wearable device, (ii) the interface to the translation service, and (iii) the translation service includes metadata indicating which of the wearer or the other person is the audience for the translation, and
the metadata indicating the audience for the translation is attached to the request by the mobile computing device.

14. The system of claim 4, wherein
at least one communication between two of (i) the wearable device, (ii) the interface to the translation service, and (iii) the translation service includes metadata indicating which of the wearer or the other person is the audience for the translation, and
the metadata indicating the audience for the translation is attached to the request by the translation service.

15. The wearable apparatus of claim 1, wherein the wearable apparatus determines whether the utterance originated from the wearer or from the other person before sending the translation request, by applying two different sets of filters to the first audio signal to produce two filtered audio signals, and comparing a speech-to-noise ratio in each of the two filtered audio signals.

16. A wearable apparatus comprising:
a loudspeaker configured to play sound into free space;
an array of microphones; and
a processor configured to:
receive inputs from each microphone of the array of microphones;
in a first mode, filter and combine the microphone inputs to operate the microphones as a beam-forming array most sensitive to sound from the expected location of the wearer of the device's own mouth;
in a second mode, filter and combine the microphone inputs to operate the microphones as a beam-forming array most sensitive to sound from a point where a person speaking to the wearer is likely to be located.

17. The wearable apparatus of claim 16, wherein the processor is further configured to:
in a third mode, filter output audio signals so that when output by the loudspeaker, they are more audible at the ears of the wearer of the apparatus than at a point distant from the apparatus; and
in a fourth mode, filter output audio signals so that when output by the loudspeaker, they are more audible at a point distant from the wearer of the apparatus than at the wearer's ears.

18. The wearable apparatus of claim 16, wherein the processor is in communication with a speech translation service, and is further configured to:
in both the first mode and the second mode, obtain translations of speech detected by the microphone array, and use the loudspeaker to play back the translation.

19. The wearable apparatus of claim 16, wherein the microphones are located in acoustic nulls of a rotation pattern of the loudspeaker.

20. The wearable apparatus of claim 16, wherein the processor is further configured to operate in both the first mode and the second mode in parallel, producing two input audio streams representing the outputs of both beam forming arrays.

21. The wearable apparatus of claim 17, wherein the processor is further configured to operate in both the third mode and the fourth mode in parallel, producing two output audio streams that will be superimposed when output by the loudspeaker.

22. The wearable apparatus of claim 21, wherein the processor is further configured to provide the same audio signals to both the third mode filtering and the fourth mode filtering.

23. The wearable apparatus of claim 21, wherein the processor is further configured to:
operate in all four of the first, second, third, and fourth modes in parallel, producing two input audio streams representing the outputs of both beam forming arrays and producing two output audio streams that will be superimposed when output by the loudspeaker.

24. The wearable apparatus of claim 23, wherein the processor is in communication with a speech translation service, and is further configured to:
obtain translations of speech in both the first and section input audio streams,
output the translation of the first audio stream using the fourth mode filtering, and
output the translation of the second audio stream using the third mode filtering.
